(19) United States
(12) Patent Application Publication
(10) Pub. No.: US 2018/0339308 A1
(43) Pub. Date: Nov. 29, 2018

(54) COATING METHOD

(71) Applicant: TORAY ENGINEERING CO., LTD., Chuo-ku, Tokyo (JP)

(72) Inventors: Kenichi SHIMATANI, Yokohama-shi, Kanagawa (JP); Satoshi TOMOEDA, Otsu-shi, Shiga (JP)

(21) Appl. No.: 15/757,773

(22) PCT Filed: Sep. 8, 2016
(86) PCT No.: PCT/JP2016/076370

§ 371 Date: Mar. 6, 2018

(30) Foreign Application Priority Data
Sep. 10, 2015 (JP) 2015-178114

(51) Int. Cl. B05D 1/26; B05D 3/06

(52) U.S. Cl. CPC B05D 1/26; B05D 3/06

(57) ABSTRACT

A coating method includes providing a substrate with a pattern region, and coating the pattern region entirely with a coating liquid to form a coating pattern. An area around the pattern region has lower lyophilicity than the pattern region. The pattern region has a lyophobic part whose lyophilicity is lower than that of a portion of the pattern region other than the lyophobic part within the pattern region.

### TECHNICAL FIELD

The present invention relates to a coating method with which a substrate is coated with a coating liquid by an inkjet method, and a coating film is formed in the desired shape.

### BACKGROUND ART

In forming a coating pattern the desired shape on a substrate W, what has often been done in recent years is to coat by an inkjet method, rather than the photolithography that was used in the past. Photolithography entails numerous steps, such as coating, exposure, and etching, and a large amount of coating material is consumed in the etching process, whereas an inkjet method involves fewer steps and a coating pattern 51 can be formed with almost no wasted coating material.

However, in the formation of a coating pattern by an inkjet method, wetting and spreading of the droplets occur after they land on the substrate W, which makes it difficult to form a coating pattern in a preset shape. In particular, the coating patterns may end up touching each other when there is only a narrow gap between coating patterns, and there is the risk that the expected performance of the coating pattern can not be realized. In view of this, as shown in the following Patent Literature 1, a method is sometimes adopted in which the lyophilicity of the substrate W is raised according to the shape of the coating pattern, and the droplets are sprayed into that portion. This makes it easier to forma coating pattern of a preset shape because the liquid wets and spreads out within the portion of higher lyophilicity.

### PRIOR ART DOCUMENT

### Patent Literature

[Patent Literature 1] Japanese Patent Application Publication No. 2005-109390

### SUMMARY OF THE INVENTION

### Problems to be Solved by the Invention

However, even when a coating pattern is formed by the above method, there is the risk that a coating pattern of the desired shape cannot be obtained with good precision. More specifically, as shown in FIG. 6(a), when the coating pattern 92 shown in FIG. 6(b) is formed by forming a pattern region 91 whose lyophilicity is higher than the surrounding area thereof on the substrate W according to the shape of the coating pattern in advance, and then coating this pattern region 91 with droplets, there is the risk that surface tension will act on the coating pattern 92 as indicated by the arrows in FIG. 6(b), so that the coating pattern 92 is pulled in toward the center of the coating pattern 92, producing unfilled parts 93 in the corners of the coating pattern 92, for example, as shown in FIG. 6(c).

The present invention was conceived in light of the above problem, and it is an object thereof to provide a coating method with which a coating pattern can be formed according to a preset shape.

### Means to Solve the Problems

To solve the above problem, the coating method of the present invention is a coating method in which an entire pattern region formed on a substrate is coated with a coating liquid, and a coating pattern having the shape of the pattern region is formed, wherein the area around the pattern region has lower lyophilicity than the pattern region, and a lyophobic part whose lyophilicity is lower than that of other portions in the pattern region is provided within the pattern region.

With the above coating method, although the coating pattern is pulled in toward its center by surface tension, there is an action of pushing back in the lyophobic part due to the provision of the lyophobic part, so distortion of the coating pattern by surface tension can be suppressed.

Also, it is preferable for the lyophobic part to be provided in the vicinity of at least the corners of the pattern region.

This makes it possible to suppress the distortion of the coating pattern at the corners where coating pattern distortion due to surface tension is most likely to occur, and allows a coating pattern with a more accurate shape to be obtained.

Also, it is preferable for the dimension of the lyophobic part to be smaller than the in-flight diameter of the coating liquid.

This makes it possible to prevent holes that open in the coating pattern due to the coating liquid being unfilled over the lyophobic part.

Also, it is preferable for the distance between the corners and the lyophobic part closest to the corners to be between 1/20 and 3 times the in-flight diameter of the coating liquid.

This allows the shape of the coating pattern corners to be made more accurate.

### Effects of the Invention

With the coating method of the present invention, a coating pattern can be formed in a preset shape.

### BRIEF DESCRIPTION OF THE DRAWINGS

FIG. 1 is a simplified diagram of a coating apparatus for performing a coating method in an embodiment of the present invention;

FIG. 2 is a diagram of the substrate pertaining to this embodiment;

FIG. 3 is a cross section of a coating pattern immediately after coating in this embodiment;

FIG. 4 is a coating pattern formed on a substrate using the coating method pertaining to this embodiment;

FIG. 5 is a diagram of a substrate pertaining to another embodiment; and

FIG. 6 is a diagram of a coating pattern formed by a conventional coating method.

### EMBODIMENTS TO CARRY OUT THE INVENTION

Embodiments of the present invention will be described through reference to the drawings.

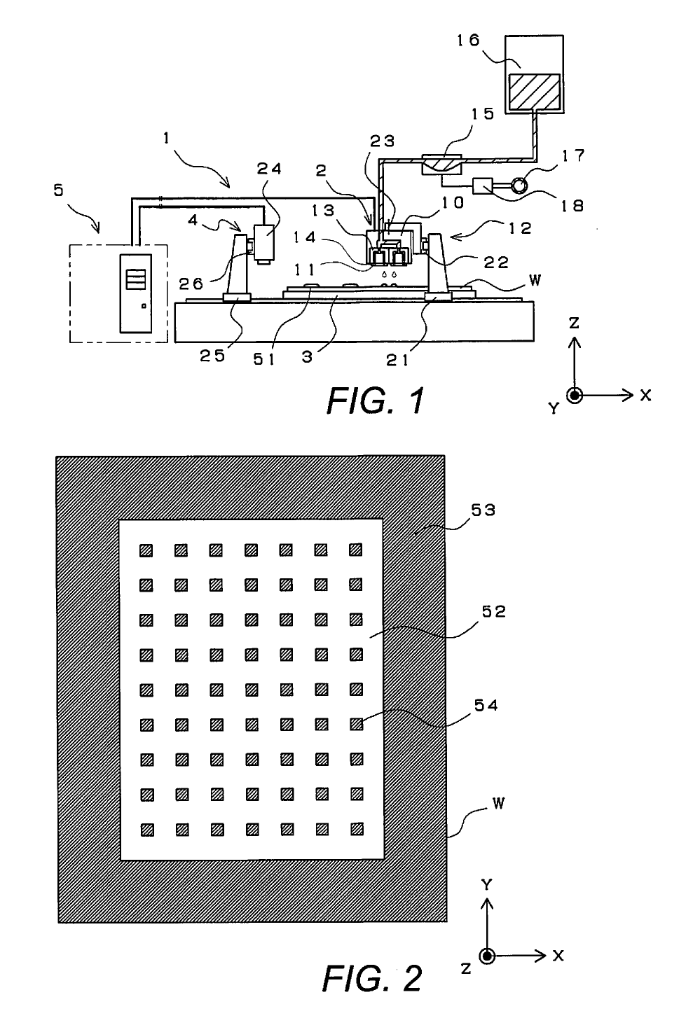

FIG. 1 is a simplified diagram of a coating apparatus for working the present invention. The coating apparatus 1 comprises a coating component 2, a coating stage 3, an alignment component 4, and a controller 5. While the coating component 2 moves over the substrate W on the coating stage 3, the droplets of coating liquid are sprayed from nozzles in the coating component 2, thereby coating the substrate W. The droplets that land on the substrate W join together, forming a coating pattern 51 on the substrate W. Before the coating component 2 sprays the droplets onto the substrate W, the alignment component 4 images alignment marks on the substrate W, and the controller 5 corrects misalignment of the substrate W by adjusting the position and angle of the coating stage 3 on the basis of the imaging result.

In the following description, the direction in which the coating component 2 moves (scans) as the droplets are sprayed onto the substrate W shall be referred to herein as the X axis direction, the direction perpendicular to the X axis direction in the horizontal plane as the Y axis direction, and the direction perpendicular to both the X axis direction and the Y axis direction as the Z axis direction.

The coating component 2 has a coating head 10 and a coating head moving device 12. The coating head 10 can be moved to the desired position of the substrate W on the coating stage 3 by the coating head moving device 12, and after moving to the spray position, the coating head 10 sprays droplets from the nozzles 11 onto the target by inkjet method.

The coating head 10 has a substantially cuboid shape whose lengthwise direction is the Y axis direction, and a plurality of spray units 13 are incorporated therein.

The spray units 13 are provided with a plurality of the nozzles 11, and the spray units 13 are incorporated into the coating head 10 so that the nozzles 11 are arranged on the lower face of the coating head 10.

The coating head 10 communicates with a sub tank 15 through a pipe. The sub tank 15 is provided near the coating head 10, and its role is to temporarily store the coating liquid supplied via a pipe from a main tank 16 provided apart from the sub tank 15, and accurately supply the coating liquid to the coating head 10. The coating liquid supplied from the sub tank 15 to the coating head 10 branches out within the coating head 10 and is supplied to all the nozzles 11 of each spray unit 13.

Each of the nozzles 11 has a drive partition wall 14, and when the controller 5 controls whether spraying from each nozzle 11 is on or off, the drive partition wall 14 of a given nozzle 11 expands and contracts to discharge droplets. In this embodiment, piezo actuators are used as the drive partition walls 14.

In order to stabilize the discharge of the droplets from the nozzles 11, it is necessary for the coating liquid to stop while maintaining an interface (meniscus) of a specific shape in each nozzle 11 during coating standby, and to this end, a specific amount of negative pressure is imparted by a vacuum source 17 in the sub tank 15. This negative pressure is regulated by a vacuum regulator valve 18 provided between the sub tank 15 and the vacuum source 17.

The coating head moving device 12 has a scanning direction moving device 21, a shift direction moving device 22, and a rotation device 23, moves the coating head 10 in the X axis direction and the Y axis direction, and rotates it in the Z axis direction (the rotational axis).

The scanning direction moving device 21 is a linear motion mechanism made up of a linear stage or the like, and its drive is controlled by the controller 5 to move the coating head 10 in the X axis direction (the scanning direction).

The scanning direction moving device 21 is driven to spray liquid droplets from the nozzles 11 while scanning by the coating head 10 above the substrate W, so that the coating liquid is continuously applied to the coating region aligned in the X axis direction.

The shift direction moving device 22 is a linear movement mechanism made up of a linear stage or the like, and its drive is controlled by the controller 5 to move the coating head 10 in the Y axis direction (the shift direction).

Consequently, when the spray units 13 are installed spaced apart within the coating head 10, coating is performed while scanning the coating head 10 in the X axis direction, after which the coating head 10 is shifted in the Y axis direction and coating is done so as to compensate for this interval, which makes it possible to coat the entire surface of the substrate W.

Also, even when the width of the substrate W in the Y axis direction is greater than the length of the coating head 10, the entire surface of the substrate W can still be coated by shifting the coating head 10 in the Y axis direction every time one coating operation is completed, and dividing up the coating into a number of passes.

The rotation device 23 is a rotary stage whose rotational axis is the Z axis direction, and its drive is controlled by the controller 5 to rotate the coating head 10.

The angle of the coating head 10 is adjusted by the rotation device 23 to adjust the spacing of the nozzles 11 in a direction (Y axis direction) perpendicular to the scanning direction of the coating head 10, and produce a spacing that is suitable for dimensions of the coating region and the size of the droplets.

The coating stage 3 has a mechanism for fixing the substrate W, and the operation of coating the substrate W is performed in a state in which the substrate W placed on the coating stage 3 and fixed. In this embodiment, the coating stage 3 has a suction mechanism, and when a vacuum pump or the like (not shown) is operated, a suction force is generated at the face in contact with the substrate W, and the substrate W is fixed there by suction.

Also, the coating stage 3 can be moved in the X axis direction and the Y axis direction by a drive device (not shown) and can rotate with the Z axis direction serving as the rotational axis. After the alignment component 4 confirms the alignment marks on the substrate W placed on the coating stage 3, the coating stage 3 moves or rotates when any deviation of the placement of the substrate W is corrected on the basis of this confirmation result. Since the purpose of the movement and rotation of the coating stage 3 the fine adjustment of the placement state of the substrate W, the distance the coating stage 3 is able to move and the angle at which it can rotate may be very small.

The alignment component 4 has an image recognition camera 24, a scanning direction moving device 25, and a shift direction moving device 26. The image recognition camera 24 is attached to the scanning direction moving device 25 and the shift direction moving device 26. These moving devices can be driven to move the image recognition camera 24 in the X axis direction and the Y axis direction.

In this embodiment, the image recognition camera 24 is a monochrome CCD camera, and the timing of image acquisition can be controlled externally. When an instruction is given by the controller 5, this image recognition camera 24 acquires image data, and the acquired image data is transferred via a cable to the controller 5.

The scanning direction moving device 25 is a linear motion mechanism made up of a linear stage or the like, and its drive is controlled by the controller 5 to move the image recognition camera 24 and the shift direction moving device 26 in the X axis direction.

The shift direction moving device 26 is a linear motion mechanism made up of a linear stage or the like, and its drive is controlled by the controller 5 to move the image recognition camera 24 in the Y axis direction.

Here, the drive of the scanning direction moving device 25 and the shift direction moving device 26 is controlled by the controller 5, and as a result the image recognition camera 24 moves relatively in the X axis direction and the Y direction with respect to the substrate W placed on the coating stage 3, and images the alignment marks on the substrate W at a plurality of positions.

The controller 5 then calculates the placement deviation of the substrate W on the basis of position information for each of the imaged alignment marks, and the controller 5 operates the coating stage 3 so as to correct this placement deviation.

The controller 5 has a computer, a sequencer, and the like, and controls operations such as the feed of liquid to the coating head 10, the discharge of droplets from the nozzles 11, the adjustment of the discharge amount, the acquisition of images by the image recognition camera 24, and the drive of the various movement mechanisms.

Also, the controller 5 has a storage device that stores various kinds of information, composed of a hard disk or a memory such as a RAM or a ROM, and coordinate data about the discharge amount of the droplets for forming a coating film in the pattern region (discussed below) in the step of applying the liquid droplets is stored in this storage device. Any other data needed for coating is also stored in this storage device.

Next, the coating method of the present invention performed using the above-mentioned coating apparatus 1 will be described.

FIG. 2 is a diagram of the substrate pertaining to this embodiment.

A pattern region 52 is provided in advance on the substrate W, before application of the coating liquid. The pattern region 52 is a region provided to match the shape of the coating pattern 51, and its lyophilicity is higher than that of the outer peripheral part 53 which is the area around the pattern region 52 (in other words, the outer peripheral part 53 has a lower lyophilicity than the pattern region 52).

One way to provide the pattern region 52 and the outer peripheral part 53 to the substrate W is to modify the surface by irradiating the substrate W with a laser beam. That is, the substrate W is initially formed only by the outer peripheral part 53, and when the desired location on the surface of the substrate W is irradiated with a laser beam, a pattern region 52 is formed in which the irradiated portion has higher lyophilicity than the outer peripheral part 53.

Thus providing the substrate W with the pattern region 52 and the outer peripheral part 53, which each have a different lyophilicity, means that when the coating liquid applied from the coating head 10 of the coating apparatus 1 to the pattern region 52 of the substrate W wets and spreads out over the substrate W, the coating liquid will stay within the pattern region 52, so the coating liquid can be prevented from wetting and spreading beyond the boundary between the pattern region 52 and the outer peripheral part 53, and a coating pattern 51 having the shape of the pattern region 52 can be easily obtained.

In this embodiment, a glass substrate, a silicon wafer, a resin film, or the like is used for the substrate W.

In the above description, the lyophilicity was raised in the portion irradiated with the laser, but conversely, the lyophilicity can be lowered in the portion irradiated with the laser. That is, it is also possible to irradiate a substrate W having high lyophilicity with a laser to form the outer peripheral part 53, and use the portion surrounded by the outer peripheral part 53 as the pattern region 52. Switching between these operations can be accomplished by means of the gas used together with laser irradiation. More specifically, the lyophilicity can be raised by performing laser irradiation of the substrate W in an atmosphere of a gas containing oxygen or nitrogen (air also corresponds to this), and the lyophilicity can be lowered by performing laser irradiation of the substrate W in an atmosphere of a fluorine-based gas.

A lyophobic part 54 whose lyophilicity is lower than that of other portions of the pattern region 52 is provided inside the pattern region 52 of the substrate W in the coating method of the present invention. In the example in FIG. 2, a plurality of lyophobic parts 54 are provided at equal intervals in the pattern region 52.

In this embodiment, the lyophobic part 54 is formed by not performing laser irradiation that raises lyophilicity. That is, laser irradiation of the substrate W is performed in a region excluding the region of the lyophobic part 54 from the pattern region 52. Therefore, a lyophobic part 54 having the same lyophilicity as the outer peripheral part 53 is formed in the pattern region 52.

The outer peripheral part 53 and the lyophobic part 54 do not necessarily need to have the same lyophilicity. Here, outer peripheral part 53 needs to prevent the coating liquid from spreading out and wetting, and considering that the coating liquid has to be on top of the lyophobic part 54, the lyophilicity of the lyophobic part 54 is preferably higher than that of the outer peripheral part 53.

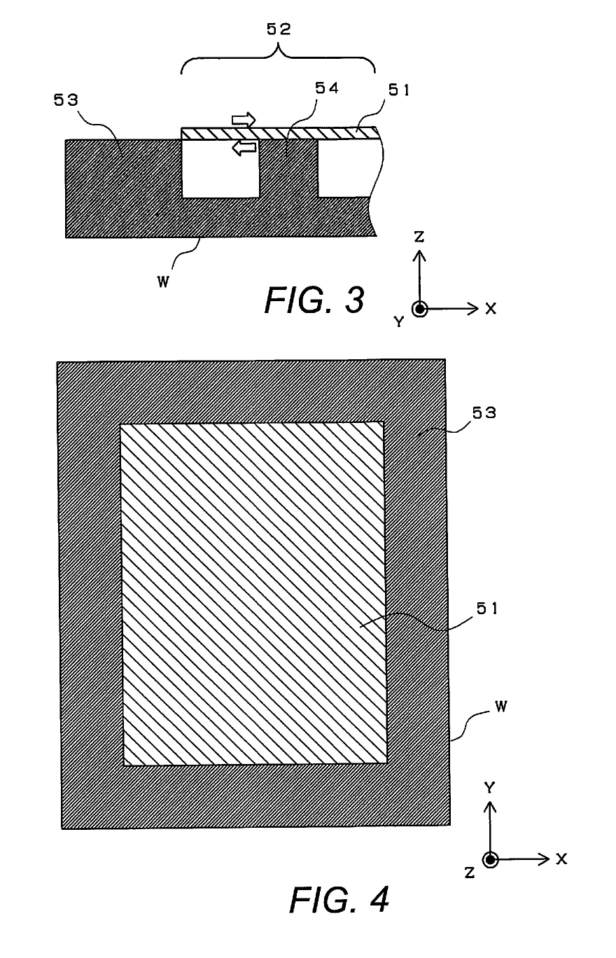

Next, the behavior of the coating pattern 51 when the pattern region 52 is coated with the coating liquid is shown in FIG. 3.

In this embodiment, in forming the coating pattern 51 on the substrate W, the coating liquid is applied over the entire pattern region 52. At this point, the coating pattern 51, and particularly in its corners, is subjected to an action whereby the coating pattern 51 is pulled in toward its center by the surface tension of the coating pattern 51 itself, as indicated by the upper arrow in FIG. 3.

On the other hand, in the portion where the lyophobic part 54 is located, as shown by the lower arrow in FIG. 3, the lyophobicity thereof causes an action that pushes the coating pattern 51 back in the opposite direction from that when it is pulled toward the center by surface tension. Therefore, distortion of the coating pattern 51 by surface tension is kept to a minimum, and as shown in FIG. 4, a coating pattern 51 having a shape conforming to the shape of the pattern region 52 can be obtained.

Here, the lyophobic part 54 is preferably provided at least in the vicinity of the corners of the pattern region 52. Doing this minimizes distortion of the coating pattern 51 in the corners where distortion of the coating pattern 51 by surface tension is most likely to occur, and a coating pattern 51 with a more accurate shape can be obtained.

If the lyophobic part 54 closest to the corners of the pattern region 52 is too far from the corners of the pattern region 52, the position where the push-back action on the coating pattern 51 is generated will be too far from the corners of the pattern region 52, so the effect of suppressing distortion of the coating pattern 51 is diminished. On the other hand, if the lyophobic part 54 closest to the corners of the pattern region 52 is too close to the corners of the pattern region 52, the droplets will tend not to go in between the corners of the pattern region 52 and the lyophobic part 54, so there is a possibility that the coating pattern 51 will have a shape in which the corners are missing. Therefore, it is preferable if the distance between the lyophobic part 54 closest to the corners of the pattern region 52 and the corners of the pattern region 52 is between 1/20 and 3 times the in-flight diameter of the coating liquid. Here, the “in-flight diameter of the coating liquid” in the present description means the diameter of the sphere when it is assumed that the shape of the coating liquid discharged from a nozzle 11 of the coating head 10 is a true sphere. More specifically, the in-flight diameter is about 12 um when 1 pl of coating solution is discharged from a nozzle 11, and the in-flight diameter is about 43 um when 42 pl of coating solution is discharged from a nozzle 11. When the distance between the lyophobic part 54 closest to the corners of the pattern region 52 and the corners of the pattern region 52 is less than the in-flight diameter of the coating liquid, it will be difficult for the coating liquid to land directly between the corners and the lyophobic part 54, but the coating liquid will fill in near the corners by working its way around after landing at the periphery of the lyophobic part 54.

Also, it is preferable for the dimensions of the lyophobic part 54 to be smaller than the in-flight diameter of the coating liquid.

This makes it possible to prevent that the coating pattern 51 has a shape with holes due to the coating liquid being unfilled over the lyophobic part 54.

The above coating method makes it possible to form a coating pattern in a preset shape.

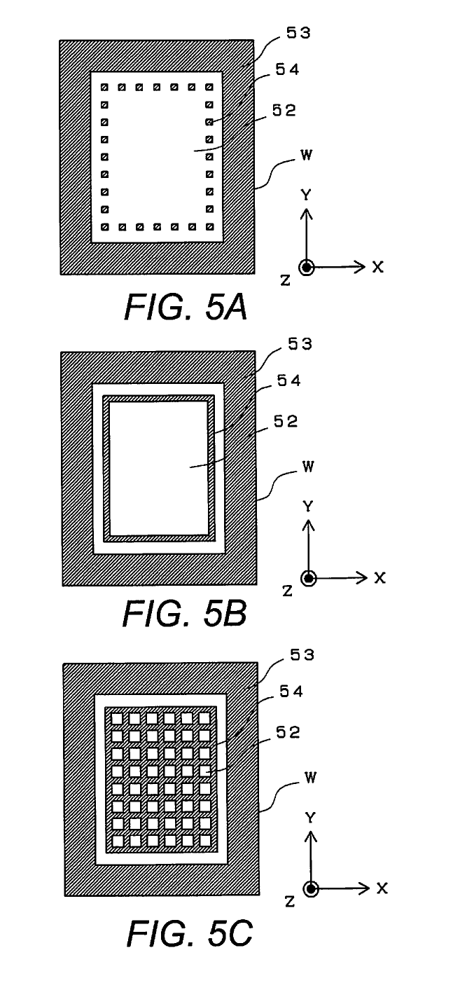

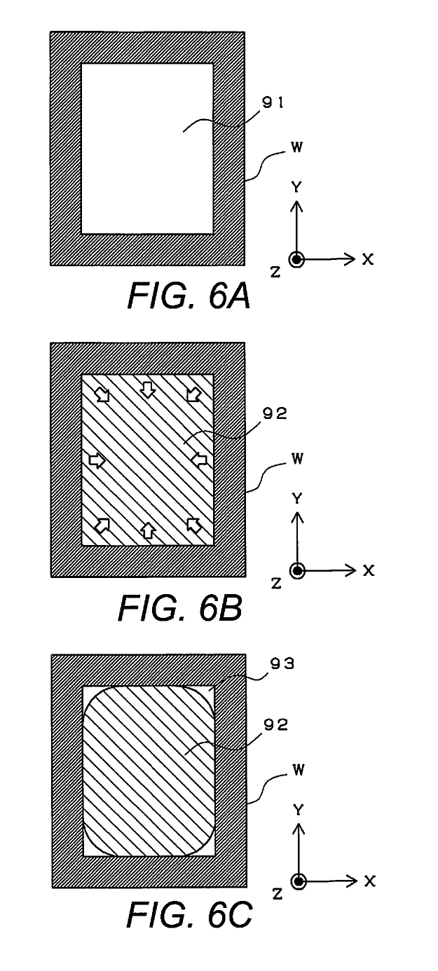

The coating method of the present invention is not limited to or by the embodiment described above, and may be of some other form within the scope of the present invention. For example, in the embodiment in FIG. 2, the lyophobic parts 54 are equidistantly spaced apart in the pattern region 52, but what is important is that they be provided at least in the corners, and they may be disposed as shown in FIGS. 5(a) to 5(c).

In the above description, the lyophilicity of the surface of the substrate W was adjusted by irradiating with a laser beam to form the pattern region 52, the outer peripheral part 53, and the lyophobic part 54, but lamp light or heat may be used instead to adjust the lyophilicity of the surface of the substrate W. For example, when lamp light is used, the surface of the substrate W is formed from a material whose lyophilicity changes when struck by light (for example, a material with which fluorine precipitates on the surface and lyophilicity decreases when struck by light), and a DMD (digital mirror device) can be used to control the projection of light onto the surface of the substrate W, so that the pattern region 52 having the desired shape is formed.

### DESCRIPTION OF THE REFERENCE NUMERALS

1 coating device

2 coating component

3 coating stage

4 alignment component

5 controller

10 coating head

11 nozzle

12 coating head moving device

13 spray unit

14 drive partition wall

15 sub tank

16 main tank

17 vacuum source

18 vacuum regulator valve

21 scanning direction moving device

22 shift direction moving device

23 rotation device

24 image recognition camera

25 scanning direction moving device

26 shift direction moving device

51 coating pattern

52 pattern region

53 outer peripheral part

54 lyophobic part

91 pattern region

92 coating pattern

93 unfilled part

W substrate

1. A coating method comprising:
providing a substrate with a pattern region; and
coating the pattern region entirely with a coating liquid to form a coating pattern,
an area around the pattern region having lower lyophilicity than the pattern region, and
the pattern region having a lyophobic part whose lyophilicity is lower than that of a portion of the pattern region other than the lyophobic part within the pattern region.

2. The coating method according to claim 1, wherein
the lyophobic part is provided at least in a vicinity of a corner of the pattern region.

3. The coating method according to claim 1, wherein
the lyophobic part has a dimension that is smaller than an in-flight diameter of the coating liquid.

4. The coating method according to claim 1, wherein
a distance between a corner of the pattern region and the lyophobic part that is closest to the corner is between 1/20 and 3 times an in-flight diameter of the coating liquid.

5. The coating method according to claim 2, wherein
the lyophobic part has a dimension that is smaller than an in-flight diameter of the coating liquid.

6. The coating method according to claim 2, wherein
a distance between the corner and the lyophobic part that is closest to the corner is between 1/20 and 3 times an in-flight diameter of the coating liquid.

7. The coating method according to claim 3, wherein
a distance between a corner of the pattern region and the lyophobic part that is closest to the corner is between 1/20 and 3 times an in-flight diameter of the coating liquid.

8. The coating method according to claim 5, wherein
a distance between the corner and the lyophobic part that is closest to the corner is between 1/20 and 3 times an in-flight diameter of the coating liquid.

9. The coating method according to claim 1, wherein
the coating pattern has a shape that corresponds to an overall shape of the pattern region.

10. The coating method according to claim 1, wherein
the lyophilicity of the lyophobic part is higher than the lyophilicity of the area around the pattern region.
